(19) United States
(12) Patent Application Publication
(10) Pub. No.: US 2025/0131822 A1
(43) Pub. Date: Apr. 24, 2025

(54) METHOD FOR AUTOMATED DRIVING MINIMUM RISK MANEUVER AND DEVICE FOR AUTOMATED DRIVING MINIMUM RISK MANEUVER

(71) Applicant: HYUNDAI MOBIS CO., LTD., Seoul (KR)

(72) Inventor: Jae Yong LEE, Yongin-si (KR)

(73) Assignee: HYUNDAI MOBIS CO., LTD., Seoul (KR)

(21) Appl. No.: 18/819,953

(22) Filed: Aug. 29, 2024

(30) Foreign Application Priority Data
Oct. 19, 2023 (KR) 10-2023-0140216

(51) Int. Cl. G08G 1/0967; B60W 30/09; G08G 1/01; G08G 1/04

(52) U.S. Cl. CPC G08G 1/096725; B60W 30/09; G08G 1/0112; G08G 1/04; B60W 2556/45

(57) ABSTRACT

A method for automated driving minimum risk maneuver and a device therefor are provided. The method includes performing a dynamic driving task (DDT) by an automated driving system (ADS), determining, by the ADS, whether a minimum risk maneuver (MRM) is needed, based on a trigger condition for the MRM, and controlling a subject vehicle (SV) to a minimum risk condition (MRC) by the ADS.

### CROSS-REFERENCE TO RELATED APPLICATION(S)

Pursuant to 35 U.S.C. § 119 (a), this application claims the benefit of earlier filing dates and right of priority to Korean Application No. 10-2023-0140216, filed on Oct. 19, 2023, the contents of which are hereby incorporated by reference herein in their entirety for all purposes.

### BACKGROUND

### 1. Field

Various embodiments relate to a method for automated driving minimum risk maneuvering and a device for automated driving minimum risk maneuver.

### 2. Description of the Related Art

Minimum Risk Maneuver (MRM) is a fallback function of an automated driving system (ADS) to achieve a Minimum Risk Condition (MRC), which is a stable stationary state. While dynamic driving is being performed by the ADS, an event may occur that prevents the ADS from continuing the dynamic driving operation. Examples of such events may include: i) errors in the automated driving system, automated driving components, or other vehicle components for ISO/SAE level 3-5 ADS, ii) a risk of shutting down an operational design domain (ODD) for/SAE Level 3 or 4 ADS. iii) the failure of a fallback ready user (FRU) or passenger to take over a dynamic driving task when the automated driving system issues an intervention request for the ISO/SAE level 3 ADS. The problem is that neither MRM nor the international standard ISO 23793-1 is specific about the trigger conditions for MRM. An efficient and reliable method for determining and controlling trigger conditions is required for MRM of an automated driving vehicle.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Embodiments provide a device and method for performing efficient and safe automated driving minimum risk maneuver.

Embodiments provide a device and method for automated driving minimum risk maneuver for performing dynamic driving safely and efficiently in automated driving of a vehicle.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

In a general aspect of the disclosure, a method for automated driving minimum risk maneuver, includes: performing a dynamic driving task (DDT) by an automated driving system (ADS); determining, by the ADS, whether a minimum risk maneuver (MRM) is needed, based on a trigger condition for the MRM; and controlling a subject vehicle (SV) to a minimum risk condition (MRC) by the ADS.

The method may further include: receiving, by the SV, information indicating an MRM activation request from an infrastructure, the infrastructure comprising a first infrastructure and a second infrastructure, and the second infrastructure positioned between the first infrastructure and the second infrastructure is adjacent to the SV; transmitting the information indicating the MRM activation request to the SV based on event information related to at least one of a vehicle accident or a structure collapse incident; transmitting, by the first infrastructure, the event information to the second infrastructure; and transmitting, by the second infrastructure, the information indicating the MRM activation request to the SV based on the event information.

The second infrastructure may be configured to, at least one of: transmit the information indicating the MRM activation request to the SV when a proportion of an area of a driving lane obstruction caused by at least one of the vehicle accident or the structure collapse incident in a driving lane of a road for the SV is greater than or equal to a threshold; transmit the information indicating the MRM activation request to the SV when a specific height of the driving lane obstruction caused by at least one of the vehicle accident or the structure collapse incident in the driving lane of the road for the SV is greater than or equal to a threshold; or a combination thereof.

The SV may receive information indicating an MRM activation request based on event information from an infrastructure adjacent to the SV, wherein the event information may include at least one of a vehicle accident, a structure collapse incident, or a combination thereof, wherein the event information may be acquired by the infrastructure based on at least one of a camera of the infrastructure, a sensor of the infrastructure, at least one vehicle neighboring the infrastructure, or any combination thereof, and wherein, at least one of: the information indicating the MRM activation request may be transmitted to the SV by the infrastructure in response to a proportion of an area of a driving lane obstruction caused by at least one of the vehicle accident or the structure collapse incident in a driving lane of a road for the SV being greater than or equal to a threshold; the information indicating the MRM activation request may be transmitted to the SV by the infrastructure in response to a specific height of the driving lane obstruction caused by at least one of the vehicle accident or the structure collapse incident in the driving lane of the road for the SV being greater than or equal to a threshold; or a combination thereof.

The SV may receive information indicating an MRM activation request from a vehicle adjacent to the SV based on event information, wherein the event information may include at least one of a vehicle accident, a structure collapse incident, or a combination thereof, wherein the event information may be acquired by the adjacent vehicle based on at least one of a camera of the adjacent vehicle, a sensor of the adjacent vehicle, at least one vehicle neighboring the adjacent vehicle, or any combination thereof, and wherein at least one of: the information indicating the MRM activation request may be transmitted to the SV by the adjacent vehicle in response to a proportion of an area of a driving lane obstruction caused by at least one of the vehicle accident or the structure collapse incident in a driving lane of a road for the SV being greater than or equal to a threshold; or the information indicating the MRM activation request may be transmitted to the SV by the adjacent vehicle in response to a specific height of the driving lane obstruction caused by at least one of the vehicle accident or the structure collapse incident in the driving lane of the road for the SV being greater than or equal to a threshold.

The method may further include at least one of: determining, by the SV, the trigger condition for the MRM based on an error occurring in at least one of a communication module or a sensing module of the SV; determining, by the SV, the trigger condition for the MRM in response to: event information including at least one of a vehicle accident or a structure collapse incident being acquired by the SV based on at least one of a camera of the SV, a sensor of the SV, or at least one vehicle neighboring the SV; and a proportion of an area of a driving lane obstruction caused by at least one of the vehicle accident or the structure collapse incident in a driving lane of a road for the SV being greater than or equal to a threshold; determining, by the SV, the trigger condition for the MRM in response to a specific height of the driving lane obstruction caused by the at least one of the vehicle accident or the structure collapse incident in the driving lane of the road for the SV being greater than or equal to a threshold; or any combination thereof.

In response to the determination that the MRM is needed based on the trigger condition for the MRM, the method may further include: selecting an MRM type based on internal and external information, and changing the selected MRM type in response to changes in at least one of internal factors, external factors, traffic conditions, or any combination thereof that exceed predetermined values.

In response to a change in the MRM type while the ADS is performing the MRM, the method may further include controlling the ADS to prevent multiple MRM type changes from delaying attainment of the MRC.

The method may further include, during a change in the MRM type, allowing a driver to take over control of the vehicle over the DDT.

In another general aspect of the disclosure. a device for automated driving minimum risk maneuver, includes: a transceiver; a memory; and a processor configured to: perform a dynamic driving task (DDT) by an automated driving system (ADS); determine whether a minimum risk maneuver (MRM) is needed based on a trigger condition for the MRM; and control a subject vehicle (SV) to a minimum risk condition (MRC).

The transceiver may receive information indicating an MRM activation request from an infrastructure, wherein the information indicating the MRM activation request may be transmitted to the SV based on event information related to at least one of a vehicle accident, a structure collapse incident, or a combination thereof, wherein the infrastructure may include a first infrastructure and a second infrastructure, wherein the second infrastructure between the first infrastructure and the second infrastructure may be adjacent to the SV, wherein the event information may be transmitted to the second infrastructure by the first infrastructure, and wherein the information indicating the MRM activation request may be transmitted to the transceiver by the second infrastructure based on the event information.

The SV may receive information indicating an MRM activation request based on event information from an infrastructure adjacent to the transceiver, wherein the event information may include at least one of a vehicle accident, a structure collapse incident, or a combination thereof, wherein the event information may be acquired by the infrastructure based on at least one of a camera of the infrastructure, a sensor of the infrastructure, at least one vehicle neighboring the infrastructure, or any combination thereof, wherein, at least one of: the information indicating the MRM activation request may be transmitted to the transceiver by the infrastructure in response to a proportion of an area of a driving lane obstruction caused by at least one of the vehicle accident or the structure collapse incident in a driving lane of a road for the SV being greater than or equal to a threshold; the information indicating the MRM activation request may be transmitted to the transceiver by the infrastructure in response to a specific height of the driving lane obstruction caused by at least one of the vehicle accident or the structure collapse incident in the driving lane of the road for the SV being greater than or equal to a threshold; or a combination thereof.

The processor may be further configured to, at least one of: determine the trigger condition for the MRM based on an error occurring in at least one of a communication module or a sensing module of the SV; determine the trigger condition for the MRM based on: event information including at least one of a vehicle accident or a structure collapse incident being acquired by the transceiver based on at least one of a camera of the SV, a sensor of the SV, at least one vehicle neighboring the SV, or any combination thereof; and a proportion of an area of a driving lane obstruction caused by at least one of the vehicle accident or the structure collapse incident in a driving lane of a road for the SV being greater than or equal to a threshold; determine the trigger condition for the MRM when a specific height of the driving lane obstruction caused by the at least one of the vehicle accident or the structure collapse incident in the driving lane of the road for the SV is greater than or equal to a threshold; or any combination thereof.

In response to the determination that the MRM is needed based on the trigger condition for the MRM, the processor may be further configured to: select an MRM type based on internal and external information; and change the selected MRM type in response to changes in at least one of internal factors, external factors, traffic conditions, or any combination thereof that exceed predetermined values.

In response to a change in the MRM type while the ADS is performing the MRM, the processor may be further configured to control the ADS to prevent multiple MRM type changes from delaying attainment of the MRC.

During a change in the MRM type, the processor may be further configured to allow a driver to take over control of the vehicle over the DDT.

Further scope of applicability of the present disclosure will become apparent from the following detailed description. Various changes and modifications within the spirit and scope of the present disclosure can be clearly understood by those skilled in the art, and therefore it is to be understood that the detailed description and specific embodiments such as preferred embodiments of the present disclosure are given by way of example only.

### BRIEF DESCRIPTION OF THE DRAWINGS

The accompanying drawings, which are included to provide a further understanding of the disclosure and are incorporated in and constitute a part of this application, illustrate embodiment(s) of the present disclosure and together with the description serve to explain the principle of the present disclosure. For a better understanding of the various embodiments described below, the following description of the embodiments should be read in conjunction with the accompanying drawings, which include corresponding parts with like reference numbers throughout the drawings. In the drawings:

FIG. 1 shows a state diagram according to embodiments;

FIG. 2 illustrates a minimal risk maneuver (MRM) according to embodiments;

FIG. 3 illustrates an MRM classification according to embodiments.

FIG. 4 illustrates a vehicle control device according to embodiments;

FIG. 5 illustrates a vehicle structure according to embodiments;

FIG. 6 illustrates MRM conditions according to embodiments;

FIG. 7 illustrates an event according to embodiments;

FIG. 8 illustrates a procedure for receiving an MRM activation request according to embodiments;

FIG. 9 illustrates data about an MRM activation request according to embodiments;

FIG. 10 illustrates a procedure for receiving an MRM activation request according to embodiments; and

FIG. 11 illustrates data about an MRM activation request according to embodiments.

### DETAILED DESCRIPTION

Preferred embodiments of the embodiments will be described in detail, examples of which are shown in the accompanying drawings. The following detailed description with reference to the accompanying drawings is intended to illustrate preferred embodiments of the embodiments rather than to present only embodiments that can be implemented in accordance with the embodiments. The following detailed description includes details to provide a thorough understanding of the embodiments. However, it will be apparent to those skilled in the art that embodiments can be practiced without these details.

Although most terms used in the embodiments have been selected from general ones widely used in the art, some terms have been arbitrarily selected by the applicant and their meanings are explained in detail in the following description as needed. Thus, the embodiments should be understood based upon the intended meanings of the terms rather than their simple names or meanings.

FIG. 1 shows a state diagram according to embodiments.

FIG. 1 shows an example MRM state diagram for MRM (3.1 Minimum Risk Maneuver). The specific states and switching conditions of MRM may vary from one automated driving system (ADS) to another.

The definitions of terms according to embodiments are as follows.

Minimum risk maneuver (MRM) refers to an operation performed by an ADS to reach a minimum risk condition. Minimum risk condition (MRC) is a stable, stationary state to which the user or ADS may bring the vehicle after performing a dynamic driving task (DDT) fallback to reduce the risk of a collision when a given movement cannot or should not be continued. Subject vehicle refers to a vehicle equipped with an ADS capable of performing MRM. Standstill management is an action taken by the ADS to maintain the vehicle in the MRC. Lane boundary refers to the boundary of a lane as determined by visible lane markings or, in the absence of visible lane markings, the boundary of a lane as determined by incidental visible road features or other means such as positioning related to digital maps, magnetic markers, etc. Road shoulder is a portion of a road that is placed at the edge of the road, outside the lane boundaries, to allow emergency vehicles to bypass traffic congestion or to provide a place for troubled vehicles to exit from moving traffic. Acceleration control refers to controls that use vehicle functions, such as powertrain control, to produce positive acceleration. Deceleration control refers to controls that use vehicle functions, such as brakes, to generate negative acceleration. ADS Active indicates that the ADS performs the entire DDT in the ADS active state, which is the ADS normal operation state or MRM state. In the case where the state is switched from the ADS Active to ADS Inactive (B), the ADS deactivation procedure defined for each ADS for the active ADS continues to apply. ADS Normal Operation means that in the ADS normal operation state, the ADS performs the DDT as the system is intended to operate. In the ADS Normal Operation state, the ADS determines whether the MRM is needed. When it is determined that the MRM is needed, the ADS switches to MRM (A). In the minimum risk maneuver state, the ADS controls its vehicle to reach the MRC state.

Abbreviations used in this document are defined as follows. ADS (Automated Driving System), DDT (Dynamic Driving Task), FRU (Fallback-Ready User), HMI (Human Machine Interface), MRM (Minimum Risk Maneuver), MRC (Minimum Risk Condition), OEDR (Object and Event Detection Response), ODD (Operational Design Domain), ROI (Region of Interest), RTI (Request to Intervene), SV (Subject Vehicle).

The MRM state is operated as follows. The ADS monitors the ADS status. The ADS determines the type of MRM. The ADS controls the subject vehicle (SV) to execute the MRM. The ADS notifies other traffic participants about the MRM execution. In the case where the SV has passengers, ADS notifies all passengers inside the SV about the MRM execution.

When the state is switched from MRM to ADS Inactive (C), the conditions for default ADS implementation in the inactive state may be applied, but additional conditions may be applied during an ongoing MRM.

In the case where the state is switched from MRM to MRC (D), the vehicle speed is set to 0 (V_sv=0 [kph]), standstill management is enabled, and a risk warning light is applied.

In the case of ADS Inactive, the ADS is released from the state and does not perform the DDT function.

The MRC is a state where the risk is minimum, for example, the subject vehicle is stable and stationary.

In the MRC state, the ADS performs standstill management. The ADS turns on risk warning lights. The ADS communicates with the activated human user.

As used herein, a vehicle may be referred to as a means of transportation, including robots, urban air mobility (UAM), and automated driving devices.

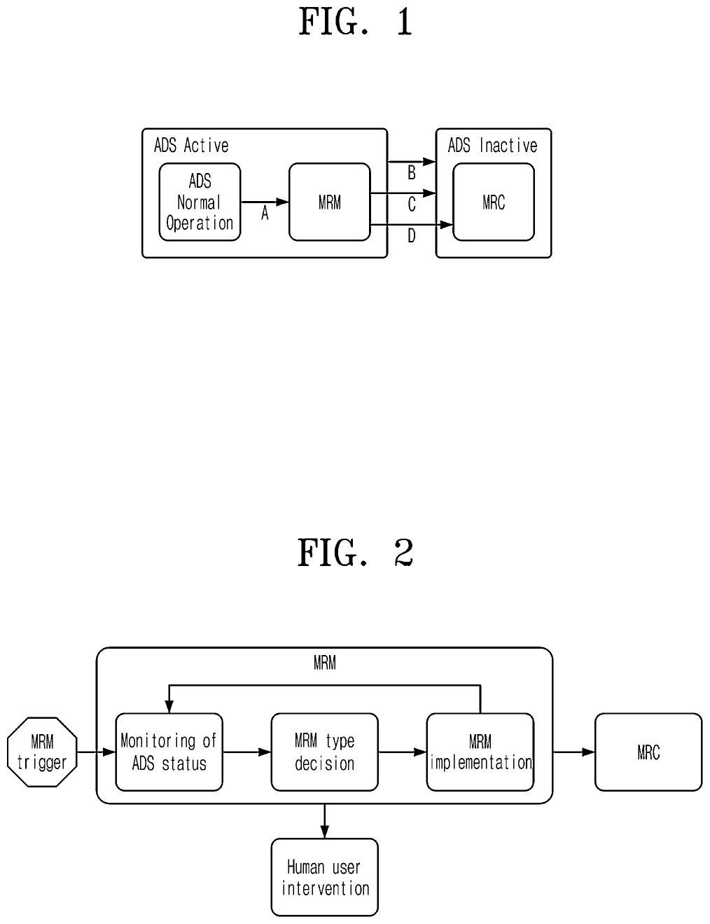

FIG. 2 illustrates a minimum risk maneuver (MRM) according to embodiments.

FIG. 2 illustrates an example MRM process for MRM. The detailed process of the MRM may vary from ADS to ADS.

When an ADS requests an MRM, the MRM is performed through the following steps

Monitoring of ADS status: First, the ADS checks the status of the system. It determines the current DDT performance capabilities of the ADS by analyzing the severity of the malfunction, identifying its impact on the system, and checking the conditions of related system components.

Determining MRM type: The most appropriate MRM type is selected. The determination includes internal (system status) and external (e.g., traffic density, ODD) information. By default, it is recommended to maintain the MRM type selection. However, the type may change if significant internal or external factors change or if changes in traffic conditions make the selected MRM infeasible. In the case where the MRM type changes while the ADS is performing the MRM, the ADS ensures that multiple MRM type changes do not delay the system from reaching the MRC in a reasonable and safe manner. MRM implementation: Includes longitudinal and lateral control to perform the selected MRM. The above steps iterate until the vehicle reaches the MRC state. During the MRM process, a human user may intervene and take over the DDT.

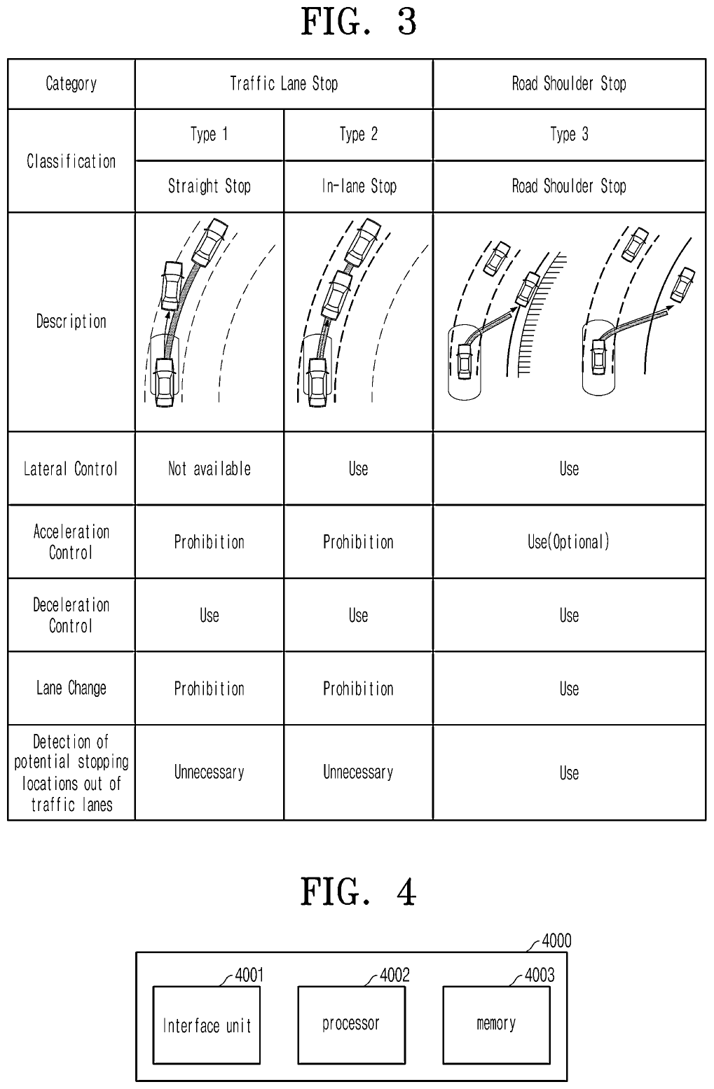

FIG. 3 shows an MRM classification.

Depending on the internal and external conditions of the ADS-equipped vehicle, the available MRMs may vary. MRMs are categorized into three types as shown in FIG. 3. The MRM types may be referred to as MRM Type 1, MRM Type 2, and MRM Type 3. MRMs may be categorized into Traffic Lane Stop and Road Shoulder Stop based on the location of the stop. Additional classes may be added according to embodiments.

MRM Type 1 represents the straight stop, where lateral control may not be available, acceleration control may be prohibited, deceleration control may be used, lane change may be prohibited, and detection of potential stopping locations out of traffic lanes may not be necessary.

MRM Type 2 represents the traffic lane stop, where lateral control may be available, acceleration control may be prohibited, deceleration control may be used, lane change may be prohibited, and detection of potential stopping locations out of lanes may be unnecessary.

MRM Type 3 represents the shoulder stop, where lateral control may be available, acceleration control may be optionally used, deceleration control may be used, lane change may be used, and detection of potential stopping locations out of lanes may be used.

The traffic lane stop is a method of emergency stopping among other road users when a critical malfunction occurs in the subject vehicle or its ADS. There are two types of traffic lane stops: straight stop and in-lane stop. The traffic lane stop may affect traffic flow and may potentially contribute to secondary collisions depending on the work area.

The straight stop is a method of stopping a vehicle using only longitudinal control without active lateral control. The straight stop uses longitudinal deceleration control to stop the vehicle when lateral control is not available. The straight stop is applied only when lateral control is not possible available (e.g., lane detection failure, malfunction of the steering actuator) or there is no lane to follow in the ODD (e.g., a valet parking system).

Because lateral control is not available during the straight stop MRM, the vehicle may cross the lane boundary or stop outside the lanes. The straight stop includes deceleration control only.

The in-lane stop is a method of stopping the vehicle within the boundaries of the lane in which the vehicle is traveling when the MRM is initiated. Longitudinal deceleration and lateral control are used, as well as environmental (sensor, map data, etc.) information about the path (and optionally a target ahead). The in-lane stop may be applied in situations where lane change is not possible or it is not possible to drive to reach a shoulder stop location. The MRC is achieved within the boundaries of the current lane.

Road shoulder stop: For road shoulder stops, both lateral and longitudinal controls are used to ensure that the subject vehicle stops as far away from the traffic flow as possible. As a result of the shoulder stop maneuver, at least a portion of the vehicle remains stationary outside the lane. The road shoulder stop maneuver is intended to minimize the impact of the MRM on nearby road users and to help passengers exit the vehicle in a safe manner.

The road shoulder stop uses both longitudinal and lateral controls as well as information about the driving environment (sensor, map data, or other means for driving environment awareness) related to the road ahead and the related lane. For road shoulder stops, the ADS may determine the location to stop the vehicle and determine whether the vehicle can reach the location to stop.

Lane boundary crossing may be determined by the ADS performing MRM, and the number of lane boundary crossings is not limited. Lane change is made only toward the target shoulder intended by the MRC. If safe interaction with other vehicles is necessary, acceleration control may be performed while driving to a potential stopping location. The MRC may be achieved on a hard road shoulder by partially or completely removing the SV from the active lane.

Changing the MRM type: During MRM execution, an additional relevant event may occur inside or outside the vehicle, or the ADS may recognize additional information. When the ADS determines that it is not appropriate to reach the initially intended MRC, the ADS may change the intended MRC to a lower MRM type. The MRM type may only be changed in one direction: from a higher type to a lower type. If the MRM type is changed while the ADS is performing the MRM, the ADS ensures that multiple MRM type changes do not delay the system from reaching the MRC in a reasonable and safe manner.

FIG. 4 illustrates a vehicle control device according to embodiments.

A vehicle control device 4000 according to the embodiments is a device that controls the operation of a vehicle according to embodiments. The vehicle control device may be referred to as an integrated autonomous vehicle controller 600. The vehicle control device may include an interface unit 4001, a processor 4002, and a memory 4003.

The memory may store instructions, signaling information, data, and the like for performing operations according to embodiments. The memory may be connected to the interface unit and the processor to transmit and receive necessary signals.

The interface unit may receive signals, information, data, and the like delivered to the vehicle control device and pass the same to the memory and/or the processor. It may also deliver signals, information, data, and the like generated by the memory and/or processor to the vehicle and/or the driver and/or passengers.

The processor may perform control operations of the vehicle according to embodiments based on the data and/or instructions stored in the memory.

The vehicle control device of FIG. 4 may correspond to a device mounted on the vehicle, or may correspond to a terminal device that controls the vehicle.

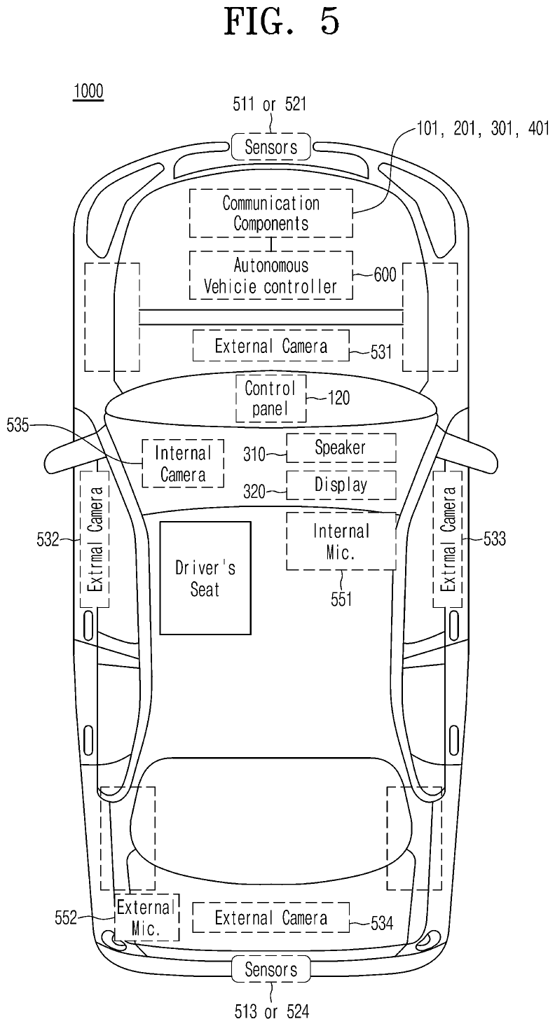

FIG. 5 illustrates a vehicle structure according to embodiments.

A vehicle according to embodiments may be configured as shown in FIG. 5 and may perform autonomous driving by an autonomous driving control system. The vehicle according to the embodiments may be referred to as an autonomous vehicle, a robot, urban air mobility (UAM), an autonomous driving device, and the like.

The autonomous vehicle 1000 may be implemented mainly based on an integrated autonomous vehicle controller 600 that transmits and receives data necessary for autonomous driving control of the vehicle through a driving information input interface 101, a travel information input interface 201, an occupant output interface 301, and a vehicle control output interface 401. The integrated autonomous vehicle controller may be referred to herein as a controller, processor, or simply a control unit.

The integrated autonomous vehicle controller may acquire driving information according to an occupant's operation of a user input unit in either an autonomous driving mode or a manual driving mode of the vehicle through the driving information input interface. The user input unit may include a driving mode switch and control panel 120 (e.g., a navigation terminal mounted on the vehicle, a smartphone or tablet carried by the occupant, etc.). Thus, the driving information may include travel mode information and navigation information about the vehicle.

In addition, the integrated autonomous vehicle controller may provide warning information along with the driving state information described above to the driver through the occupant output interface when it is determined that the driver needs to be warned in the autonomous driving mode or manual driving mode of the vehicle. A speaker 310 and a display 320 may be included to audibly and visually output such travel state information and warning information. The display may be implemented as the same device as the control panel described above, or may be implemented as a separate, independent device.

Further, the integrated autonomous driving controller may communicate control information for controlling the driving of the vehicle in the autonomous driving mode or manual driving mode of the vehicle to sub-control systems applied to the vehicle via the vehicle control output interface. The sub-control systems for controlling the driving of the vehicle may include at least one of a motor control system, an engine control system, a brake control system, and a steering control system. The integrated autonomous vehicle controller may communicate at least one of the motor control information, the engine control information, the brake control information, and the steering control information as control information to each of the sub-control systems via the vehicle control output interface.

The integrated autonomous driving controller may acquire driving information according to the driver's operation and travel information indicative of the travel state of the vehicle via the driving information input interface and the travel information input interface, respectively, and may provide travel state information and warning information generated based on the autonomous driving algorithm via the occupant output interface.

To ensure reliable autonomous driving of the vehicle, the autonomous driving device according to embodiments may include sensors configured to detect objects around the vehicle, such as neighboring vehicles, pedestrians, roads, or fixed facilities (e.g., traffic lights, milestones, traffic signs, construction fences, etc.).

The sensors may include one or more of a LiDAR sensor, a radar sensor, and a camera sensor to detect nearby objects outside of the vehicle. The sensors may include a front LiDAR sensor 511, a front radar sensor 521, a rear LiDAR sensor 513, a rear radar sensor 524, a left camera sensor 532, a right camera sensor 533, an internal camera sensor 535, a front camera sensor 531, and a rear camera sensor 534. The sensors may be associated with microphones 551 and 552.

Preferred embodiments of the embodiments will be described in detail, examples of which are shown in the accompanying drawings. The following detailed description with reference to the accompanying drawings is intended to illustrate preferred embodiments of the embodiments rather than to present only embodiments that can be implemented in accordance with the embodiments. The following detailed description includes details to provide a thorough understanding of the embodiments. However, it will be apparent to those skilled in the art that embodiments can be practiced without these details.

A method for automated driving MRM and a device for automated driving MRM according to embodiments may be referred to simply as a method/device according to embodiments. The method/device according to embodiments may define MRM trigger conditions for an automated driving vehicle and perform MRM based on the trigger conditions. The international standard ISO 23793-1 (Minimum Risk Maneuver) MRM discloses the concept of an automated driving vehicle reaching a minimum risk condition (MRC) by a minimum risk maneuver (MRM). The conventional technology, e.g., International Standard ISO 23793-1, does not specifically disclose the trigger conditions for MRM.

Accordingly, embodiments specify how to reach an MRC by MRM. Specifically, they provide trigger conditions for the MRM. Thus, by providing the trigger conditions for the MRM, the embodiments may clarify the conditions for an automated/autonomous driving system (ADS) vehicle to enter an MRM state. The ADS vehicle has the same concept as the subject vehicle (SV) in the international standard issued by ISO/TC204/WG14. SVS refers to a vehicle with an ADS-related device capable of performing MRM.

Referring to FIG. 1, a method for automated driving MRM according to embodiments may include performing a dynamic driving task (DDT) by an automated driving system (ADS), determining, by the ADS, whether a minimum risk maneuver (MRM) is needed based on a trigger condition for the MRM, and controlling a subject vehicle (SV) to a minimum risk condition (MRC) by the ADS. The trigger condition for the MRM is a condition related to determining whether to perform MRM by the ADS, and it may be determined to trigger and perform the MRM based on information acquired by an external entity or the ADS vehicle.

Referring to FIG. 4, a device for automated driving MRM according to embodiments may include a transceiver 4001 (corresponding to an interface unit), a memory 4003, and a processor 4002. The processor may perform a dynamic driving task (DDT) by an ADS, determine whether an MRM is needed based on a trigger condition for the MRM, and control a SV to a MRC. The transceiver may receive MRM activation request information from the infrastructure and/or a neighboring vehicle.

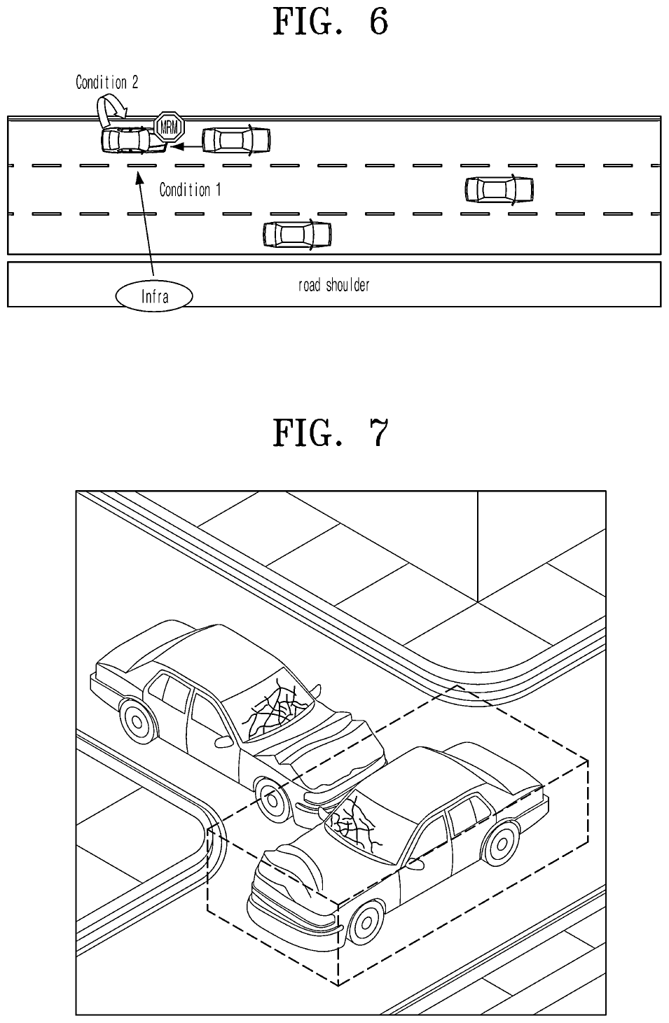

FIG. 6 illustrates MRM conditions according to embodiments.

The ADS of FIG. 1, the SV of FIG. 5 for the ADS, the MRM device of FIG. 4 for the SV may control MRM based on the trigger conditions for MRM as shown in FIG. 6.

The trigger conditions for MRM according to embodiments may include a first condition and a second condition.

The first condition is that MRM activation request information is received from an external entity. The external entity is an infrastructure, such as a vehicle and facilities around a road. For example, it includes traffic lights, street lights, utility poles, and traffic safety fences. The first condition may include receiving MRM activation request information from an infrastructure and/or receiving MRM activation request information from a vehicle neighboring the SV.

The second condition is that an MRM trigger is determined and MRM is performed through self-sensing of the ADS vehicle.

Referring to FIG. 6, the first condition is a condition for receiving an MRM activation request for an MRM trigger from a road or a facility adjacent to the vehicle (hereinafter referred to as infra) and/or a neighboring vehicle around the SV (e.g., a vehicle in front of the SV, a vehicle behind the SV, a vehicle on the side, etc.). The second condition is a condition for the SV to determine the MRM trigger through sensing/communication module or the like in the vehicle and perform MRM activation. In the following, conditions 1 and 2 are described with reference to the respective drawings.

When an MRM activation request is received from an external entity according to the first condition, the MRM activation request from the infrastructure may be received by the transceiver 4001, which is connected to the processor 4002 that controls the ADS and MRM of the SV.

For example, the infrastructure according to the embodiments refers to facilities located in the environment surrounding the SV, and may be divided into infra-near infrastructure (hereinafter, “infra-near”) and infra-far infrastructure (hereinafter, “infra-far”) located further away from the SV than the infra-near infrastructure, based on the distance between the SV and the facility. The infra-near receives event information from the infra-far and may determine whether to transmit an MRM activation request to the SV, which is an ADS vehicle. Infra-near and Infra-far refer to traffic lights, street lights, utility poles, traffic safety fences, and the like which are equipped with IT functions. The event information according to the embodiments includes information related to occurrence of a vehicle accident, a traffic structure collapse, and the like. Regarding the occurrence of a vehicle accident, the event may be a collision between vehicles, a collision between a vehicle and a traffic structure, or the like.

The infra-far may acquire the image information about the vehicle accident the root a camera. The infra-far may generate or derive the vehicle accident image information based on image information received from the at least one neighboring vehicle and location information about the at least one neighboring vehicle (e.g., GPS/V2X positioning). The infra-far may acquire LiDAR-image information related to the occurrence of a vehicle accident using LiDAR, or acquire radar detection data related to the occurrence of a vehicle accident with radar. Regarding the traffic structure collapse, the event may be collapse of a traffic signal support, collapse of a pedestrian bridge, etc. The infra-far may acquire event information about a traffic structure collapse, such as a vehicle accident, with a camera, LiDAR, or radar.

The acquired event information may be transmitted from the infra-far to the infra-near. Based on the event information, the infra-near may determine whether to transmit an MRM activation request to the ADS vehicle. To determine whether to transmit the MRM activation request, a value related to the event may be compared to a threshold, as shown in FIG. 7.

FIG. 7 illustrates an event according to embodiments.

FIG. 7 illustrates an event described above. It illustrates a vehicle accident that obstructs the travel of a vehicle on a lane of a road and poses a risk to automated driving. A vehicle involved in an accident may block the driving lane. In addition to vehicles, structures may collapse or fall into the lane and block the lane. In such cases, the infra-near or the ADS may receive event information from the infra-far ahead and determine whether to transmit an MRM activation request to the ADS vehicle based on the event information. The infra-near may analyze the event information and decide to transmit an MRM activation request if, for example, a vehicle accident or collapse of a traffic structure has eliminated a lane for the vehicle to move along. Whether the vehicle can pass along the driving road may be determined by, for example, reading an image and determining whether a proportion of an imaginary cube containing both lanes of the road occupied by objects such as accident debris is greater than or equal to a threshold. The imaginary cube is a bounding box containing the accident debris. The threshold may be generated as follows:

Threshold≤(the area occupied by the object)/(the area of the imaginary cube)

The proportion of the area occupied by objects in the accident debris is greater than or equal to the threshold, the infra-near or the ADS may determine that the vehicle cannot pass through the road. Whether the vehicle can pass along the driving road may be determined based not only on the proportion of the area but also on whether the height of the debris object is greater than or equal to a threshold height. When the height of the object is greater than the threshold value of the lower bumper of the vehicle, the vehicle cannot pass through, and it may be determined that the vehicle cannot pass through the driving road.

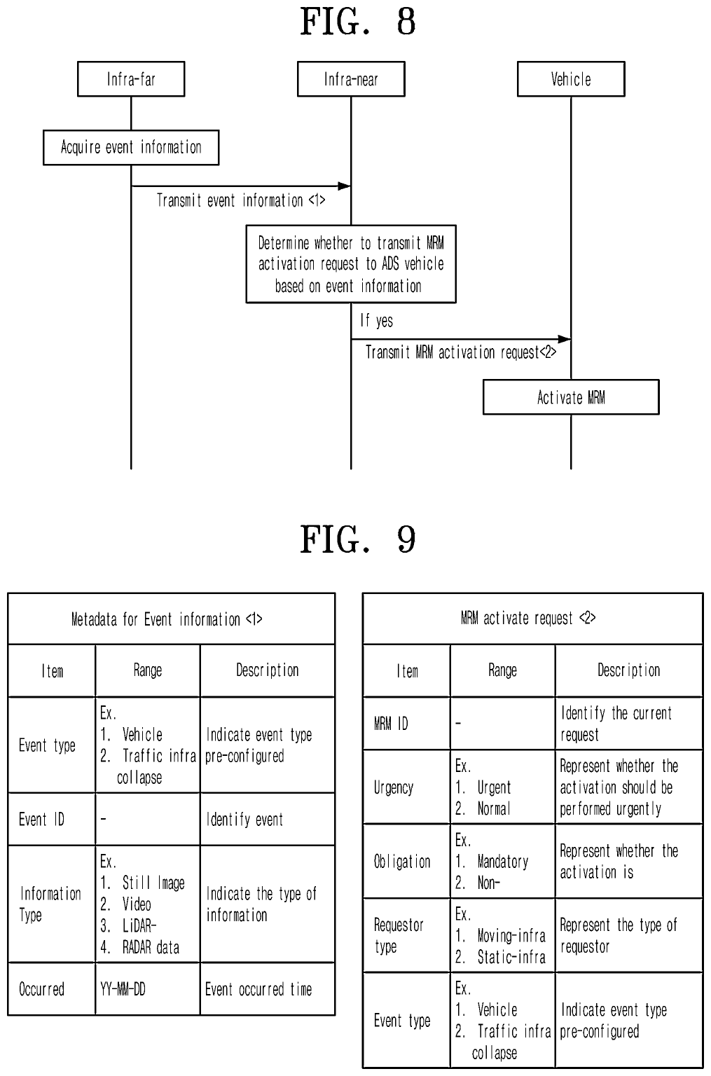

FIG. 8 illustrates a procedure for receiving an MRM activation request according to embodiments.

FIG. 8 illustrates a procedure performed for a SV to receive an MRM activation request from the infrastructure described above. The infra-far acquires event information based on image information acquired by a camera, a neighboring vehicle, location information, LiDAR sensing information, and the like. The infra-near receives the event information from the infra-far. The infra-near determines whether to transmit an MRM activation request to the ADS vehicle based on the event information. When MRM activation is needed to according the above-described threshold comparison/determination, the infra-near transmits the MRM activation request information to the ADS vehicle. The vehicle that receives the MRM activation request performs MRM.

FIG. 9 illustrates data about an MRM activation request according to embodiments.

FIG. 9 illustrates a configuration of event information and a configuration of MRM activation request information applied in the above-described procedure for receiving an MRM activation request.

The event information may include an event type, an event ID, an information type, and a date item. The event type indicates whether the object produced by the event is an object due to a vehicle accident or a traffic infrastructure collapse. The event type may indicate an event type pre-configured by the ADS. The event ID is an event identifier. The information type indicates the type of information, such as whether the event information is a still image, video, LiDAR data, or radar data. The date indicates the date and time of the event.

The MRM activation request information may include an MRM ID, urgency, obligation, requester type, and event type. The MRM ID is the identifier of the current MRM activation request information. The urgency indicates whether the priority of the MRM activation request is normal or urgent. The urgency indicates whether the MRM activation request processing should be performed urgently. The obligation indicates whether MRM activation is mandatory or not. When the value of obligation indicates mandatory, the vehicle is required to perform MRM. When the value of obligation indicates non-mandatory, the vehicle may perform MRM optionally. The requester type indicates the subject of the MRM activation request. It indicates whether the MRM activation request is made by a dynamic infrastructure or a static infrastructure. The event type indicates whether the object produced by the event results from a vehicle accident or a traffic infrastructure collapse. The event type may indicate an event type pre-configured by the ADS.

The automated driving MRM method and automated driving MRM device according to the embodiments may determine whether to transmit an MRM activation request to the ADS vehicle based on the information acquired by the infra-near, rather than the infra-far. The infra-near may acquire event information as follows. The event information is defined as described above. The infra-near may acquire the event information (image) with a camera. The infra-near may generate/derive event information (images) based on image information received from at least one neighboring vehicle and location information (GPS/V2X positioning, etc.) about the at least one neighboring vehicle. The infra-near may acquire LiDAR-image information related the event with LIDAR, or acquire radar detection data about the event with radar.

Based on the acquired event information, the intra-near may determine whether to transmit an MRM activation request to the ADS vehicle. As described above, the proportion of the area occupied by the object in the event, the height of the object, and the like may be compared with a threshold to determine whether the vehicle cannot pass through the driving lane.

Referring to FIGS. 7 to 9, a SV may receive information indicating a request for MRM activation from an infrastructure. The information indicating the MRM activation request may be transmitted to the SV based on event information about at least one of a vehicle accident or a structure collapse incident. The infrastructure may include a first infrastructure and a second infrastructure. The first infrastructure may transmit the event information to the second infrastructure, and the second infrastructure may transmit the information indicating the MRM activation to the SV based on the event information. The first infrastructure represents the infra-far, and the second infrastructure represents the infra-near.

Referring to FIGS. 7 to 9, the second infrastructure may transmit the information indicating the MRM activation request to the SV when a proportion of an area of a driving lane obstruction caused by at least one of the vehicle accident or the structure collapse incident in a driving lane of a road for the SV is greater than or equal to a threshold; or may transmit the information indicating the MRM activation request to the SV when a specific height of the driving lane obstruction caused by at least one of the vehicle accident or the structure collapse incident in the driving lane of the road for the SV is greater than or equal to a threshold. The proportion of the area of the object related to the event may be determined as the ratio of the volume of the object to the volume of the bounding box surrounding the object. The bounding box may be an imaginary cube and may be a reference area for determining whether the vehicle cannot pass through the driving lane.

FIG. 10 illustrates a procedure for receiving an MRM activation request according to embodiments.

FIG. 10 is a flowchart of the operations described in FIG. 9. The infra-near acquire the event information as described above. Based on the event information, the infra-near determines whether to transmit the MRM activation request information to the ADS vehicle based on a threshold. When the trigger condition for MRM is satisfied, the vehicle receives the MRM activation request information from the intra-near and performs MRM.

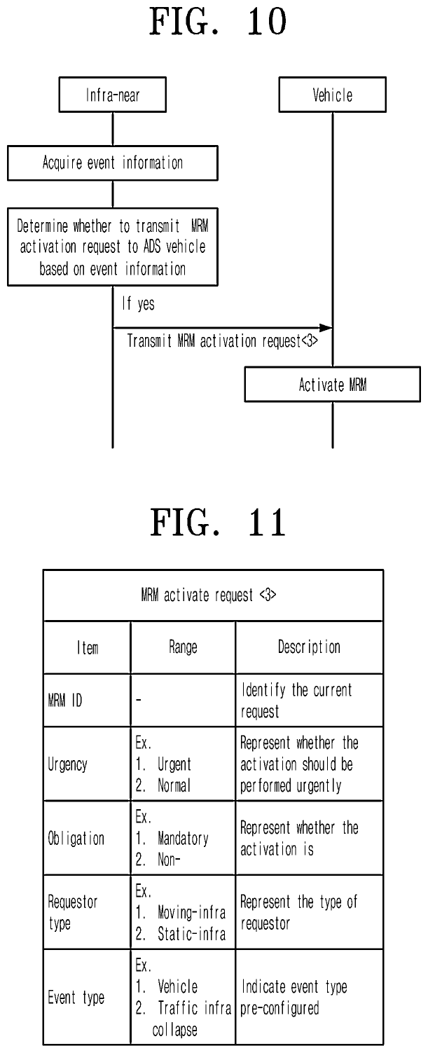

FIG. 11 illustrates data about an MRM activation request according to embodiments.

FIG. 11 illustrates a configuration of MRM activation request information applicable to the operations described in FIGS. 9 and 10.

The MRM activation request information may include an MRM ID, urgency, obligation, requester type, and event type. The MRM ID is the identifier of the current MRM activation request information. The urgency indicates whether the priority of the MRM activation request is normal or urgent. The urgency indicates whether the MRM activation request processing should be performed urgently. The obligation indicates whether MRM activation is mandatory or not. When the value of obligation indicates mandatory, the vehicle is required to perform MRM. When the value of obligation indicates non-mandatory, the vehicle may perform MRM optionally. The requester type indicates the subject of the MRM activation request. It indicates whether the MRM activation request is made by a dynamic infrastructure or a static infrastructure. The event type indicates whether the object produced by the event results from a vehicle accident or a traffic infrastructure collapse. The event type may indicate an event type pre-configured by the ADS.

The automated driving MRM method and automated driving MRM device according to the embodiments may receive an MRM activation request from a neighboring vehicle around the SV. A front vehicle which is the neighboring vehicle may transmit the MRM activation request to the rear vehicle (ADS vehicle) based on the driving state thereof. The front vehicle may transmit the MRM activation request to the rear vehicle (ADS vehicle) after it decides to enter/switch to the MRM state. The neighboring vehicle may enter the MRM state based on event information (such as a vehicle accident). In this case, the rear vehicle (ADS vehicle) may receive an MRM request from the infrastructure, or may receive an MRM request from a neighboring vehicle. The SV may receive an MRM activation request from the infrastructure or from a neighboring vehicle, prioritizing the fastest MRM in a dangerous situation. The neighboring vehicle include vehicles in front of, behind, or on the side of the SV.

The neighboring vehicle may acquire event information and determine whether to transmit the MRM activation request information to the ADS vehicle based on the event information. When the MRM activation trigger is satisfied, the ADS vehicle receives the MRM activation request. The neighboring vehicle analyzes the event information and compares the proportion of the area of the object and/or the height of an object related to the event with the respective thresholds, as described above, and transmits the MRM activation request to the ADS vehicle when the vehicle cannot pass through the driving road.

The automated driving MRM method and automated driving MRM device according to the embodiments may determine the MRM trigger through self-sensing of the ADS vehicle. The ADS of the ADS vehicle may include at least one sensing/communication module. When a module of the ADS malfunctions or detects an error, the MRM trigger may be determined.

For example, when a communication module of the ADS malfunctions or undergoes an error, the ADS vehicle may detect the malfunctioning/error of the communication module and determine an MRM trigger. Malfunctioning/error of a cellular communication module may be detected in the following cases: there is a point in time when no Uu configuration is present between the cellular communication module and the base station (eNB, gNB, etc.); the state of having no Uu configuration between the cellular communication module and the base station is maintained for more than a first threshold time; the cellular communication module transmits a HARQ NACK to the base station more than a threshold number of times in a row; the power supply to the cellular communication module is interrupted. In these cases, it is determined that there is a malfunctioning/error. A malfunctioning or error of the Wi-Fi communication module may be detected in the following cases: there is a point in time when there is no AP connected to the Wi-Fi communication module; the state of absence of any AP connected to the Wi-Fi communication module is maintained for more than a second threshold time; power supply to the Wi-Fi communication module is interrupted. In these cases, it is determined that there is a malfunctioning/error.

For example, a malfunctioning/error of the sensing module of the ADS may be detected in the following cases: Power supply to the sensing module (camera, LiDAR, radar, etc.) is interrupted; a malfunctioning detection sensor included in the sensing module indicates a malfunctioning/error in the sensing module. In these cases, the malfunctioning/error may be determined.

The ADS vehicle may acquire event information. The ADS vehicle may acquire the event information and determine whether to activate the MRM by determining the MRM trigger condition based on the event information. The ADS vehicle may activate the MRM when the vehicle cannot pass through the driving lane as a result of comparison between a proportion of the area of the object and/or a height of the object related to the event and the respective thresholds, as described above.

Referring to FIGS. 11 to 12, the SV may receive information indicating an MRM activation request based on event information from an infrastructure adjacent to the SV, wherein the event information may include at least one of a vehicle accident or a structure collapse incident. The event information may be acquired by the infrastructure based on at least one of a camera of the infrastructure, a sensor of the infrastructure, or at least one vehicle neighboring the infrastructure. The information indicating the MRM activation request may be transmitted to the SV by the infrastructure when a proportion of an area of a driving lane obstruction caused by at least one of the vehicle accident or the structure collapse incident in a driving lane of a road for the SV is greater than or equal to a threshold. Alternatively, the information indicating the MRM activation request may be transmitted to the SV by the infrastructure when a specific height of the driving lane obstruction caused by at least one of the vehicle accident or the structure collapse incident in the driving lane of the road for the SV is greater than or equal to a threshold. Based on the event information acquired by the intra-near, an MRM trigger of the SV may be determined.

Also, the SV may receive information indicating an MRM activation request from a vehicle adjacent to the SV based on event information, wherein the event information may include at least one of a vehicle accident or a structure collapse incident. The event information may be acquired by the adjacent vehicle based on at least one of a camera of the adjacent vehicle, a sensor of the adjacent vehicle, or at least one vehicle neighboring the adjacent vehicle. The information indicating the MRM activation request may be transmitted to the SV by the adjacent vehicle when a proportion of an area of a driving lane obstruction caused by at least one of the vehicle accident or the structure collapse incident in a driving lane of a road for the SV is greater than or equal to a threshold. Alternatively, the information indicating the MRM activation request may be transmitted to the SV by the adjacent vehicle when a specific height of the driving lane obstruction caused by at least one of the vehicle accident or the structure collapse incident in the driving lane of the road for the SV is greater than or equal to a threshold. Based on the event information received by the SV from the infrastructure as well as from a neighboring vehicle around the SV, an MRM trigger for the SV may be determined.

Further, the SV may determine the trigger condition for the MRM based on an error occurring in at least one of a communication module or a sensing module of the SV. Alternatively, the SV may determine the trigger condition for the MRM when event information including at least one of a vehicle accident or a structure collapse incident is acquired by the SV based on at least one of a camera of the SV, a sensor of the SV, or at least one vehicle neighboring the SV, and a proportion of an area of a driving lane obstruction caused by at least one of the vehicle accident or the structure collapse incident in a driving lane of a road for the SV is greater than or equal to a threshold. Alternatively, the SV may determine the trigger condition for the MRM when a specific height of the driving lane obstruction caused by the at least one of the vehicle accident or the structure collapse incident in the driving lane of the road for the SV is greater than or equal to a threshold. The sensing of the SV may allow MRM to be triggered more quickly.

While conditions and methods for triggering an MRM of an automated driving vehicle have not been provided in the related art, the trigger conditions for MRM according to embodiments may enable an ADS vehicle to perform MRM quickly, safely, and accurately.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. Further, the processor may be implemented as an encoder/decoder or the like for the operations of the embodiments described above.

As described above, related details have been described in the best mode for carrying out the embodiments.

As described above, the embodiments are fully or partially applicable to autonomous valet driving devices and systems.

Those skilled in the art may change or modify the embodiments in various ways within the scope of the embodiments.

Embodiments may include variations/modifications within the scope of the claims and their equivalents.

What is claimed is:

1. A method for automated driving minimum risk maneuver, the method comprising:
performing a dynamic driving task (DDT) by an automated driving system (ADS);
determining, by the ADS, whether a minimum risk maneuver (MRM) is needed, based on a trigger condition for the MRM; and
controlling a subject vehicle (SV) to a minimum risk condition (MRC) by the ADS.

2. The method of claim 1, further comprising:
receiving, by the SV, information indicating an MRM activation request from an infrastructure, the infrastructure comprising a first infrastructure and a second infrastructure, and the second infrastructure positioned between the first infrastructure and the second infrastructure is adjacent to the SV;
transmitting the information indicating the MRM activation request to the SV based on event information related to at least one of a vehicle accident or a structure collapse incident;
transmitting, by the first infrastructure, the event information to the second infrastructure; and
transmitting, by the second infrastructure, the information indicating the MRM activation request to the SV based on the event information.

3. The method of claim 2, wherein the second infrastructure is configured to, at least one of:
transmit the information indicating the MRM activation request to the SV when a proportion of an area of a driving lane obstruction caused by at least one of the vehicle accident or the structure collapse incident in a driving lane of a road for the SV is greater than or equal to a threshold;
transmit the information indicating the MRM activation request to the SV when a specific height of the driving lane obstruction caused by at least one of the vehicle accident or the structure collapse incident in the driving lane of the road for the SV is greater than or equal to a threshold; or
a combination thereof.

4. The method of claim 1,
wherein the SV receives information indicating an MRM activation request based on event information from an infrastructure adjacent to the SV,
wherein the event information comprises at least one of a vehicle accident, a structure collapse incident, or a combination thereof,
wherein the event information is acquired by the infrastructure based on at least one of a camera of the infrastructure, a sensor of the infrastructure, at least one vehicle neighboring the infrastructure, or any combination thereof, and
wherein, at least one of:
the information indicating the MRM activation request is transmitted to the SV by the infrastructure in response to a proportion of an area of a driving lane obstruction caused by at least one of the vehicle accident or the structure collapse incident in a driving lane of a road for the SV being greater than or equal to a threshold;
the information indicating the MRM activation request is transmitted to the SV by the infrastructure in response to a specific height of the driving lane obstruction caused by at least one of the vehicle accident or the structure collapse incident in the driving lane of the road for the SV being greater than or equal to a threshold; or
a combination thereof.

5. The method of claim 1,
wherein the SV receives information indicating an MRM activation request from a vehicle adjacent to the SV based on event information,
wherein the event information comprises at least one of a vehicle accident, a structure collapse incident, or a combination thereof,
wherein the event information is acquired by the adjacent vehicle based on at least one of a camera of the adjacent vehicle, a sensor of the adjacent vehicle, at least one vehicle neighboring the adjacent vehicle, or any combination thereof, and
wherein at least one of:
the information indicating the MRM activation request is transmitted to the SV by the adjacent vehicle in response to a proportion of an area of a driving lane obstruction caused by at least one of the vehicle accident or the structure collapse incident in a driving lane of a road for the SV being greater than or equal to a threshold; or
the information indicating the MRM activation request is transmitted to the SV by the adjacent vehicle in response to a specific height of the driving lane obstruction caused by at least one of the vehicle accident or the structure collapse incident in the driving lane of the road for the SV being greater than or equal to a threshold.

6. The method of claim 1, further comprising at least one of:
determining, by the SV, the trigger condition for the MRM based on an error occurring in at least one of a communication module or a sensing module of the SV;
determining, by the SV, the trigger condition for the MRM in response to:
event information including at least one of a vehicle accident or a structure collapse incident being acquired by the SV based on at least one of a camera of the SV, a sensor of the SV, or at least one vehicle neighboring the SV; and
a proportion of an area of a driving lane obstruction caused by at least one of the vehicle accident or the structure collapse incident in a driving lane of a road for the SV being greater than or equal to a threshold;
determining, by the SV, the trigger condition for the MRM in response to a specific height of the driving lane obstruction caused by the at least one of the vehicle accident or the structure collapse incident in the driving lane of the road for the SV being greater than or equal to a threshold; or
any combination thereof.

7. The method of claim 1, wherein, in response to the determination that the MRM is needed based on the trigger condition for the MRM, the method further comprises:
selecting an MRM type based on internal and external information, and
changing the selected MRM type in response to changes in at least one of internal factors, external factors, traffic conditions, or any combination thereof that exceed predetermined values.

8. The method of claim 7, wherein in response to a change in the MRM type while the ADS is performing the MRM, the method further comprises controlling the ADS to prevent multiple MRM type changes from delaying attainment of the MRC.

9. The method of claim 7, further comprising:
during a change in the MRM type, allowing a driver to take over control of the vehicle over the DDT.

10. A device for automated driving minimum risk maneuver, the device comprising:
a transceiver;
a memory; and
a processor configured to:
perform a dynamic driving task (DDT) by an automated driving system (ADS);
determine whether a minimum risk maneuver (MRM) is needed based on a trigger condition for the MRM; and
control a subject vehicle (SV) to a minimum risk condition (MRC).

11. The device of claim 10,
wherein the transceiver receives information indicating an MRM activation request from an infrastructure,
wherein the information indicating the MRM activation request is transmitted to the SV based on event information related to at least one of a vehicle accident, a structure collapse incident, or a combination thereof,
wherein the infrastructure comprises a first infrastructure and a second infrastructure,
wherein the second infrastructure between the first infrastructure and the second infrastructure is adjacent to the SV,
wherein the event information is transmitted to the second infrastructure by the first infrastructure, and
wherein the information indicating the MRM activation request is transmitted to the transceiver by the second infrastructure based on the event information.

12. The device of claim 10,
wherein the SV receives information indicating an MRM activation request based on event information from an infrastructure adjacent to the transceiver,
wherein the event information comprises at least one of a vehicle accident, a structure collapse incident, or a combination thereof,
wherein the event information is acquired by the infrastructure based on at least one of a camera of the infrastructure, a sensor of the infrastructure, at least one vehicle neighboring the infrastructure, or any combination thereof,
wherein, at least one of:
the information indicating the MRM activation request is transmitted to the transceiver by the infrastructure in response to a proportion of an area of a driving lane obstruction caused by at least one of the vehicle accident or the structure collapse incident in a driving lane of a road for the SV being greater than or equal to a threshold;
the information indicating the MRM activation request is transmitted to the transceiver by the infrastructure in response to a specific height of the driving lane obstruction caused by at least one of the vehicle accident or the structure collapse incident in the driving lane of the road for the SV being greater than or equal to a threshold; or
a combination thereof.

13. The device of claim 10,
wherein the processor is further configured to, at least one of:
determine the trigger condition for the MRM based on an error occurring in at least one of a communication module or a sensing module of the SV;
determine the trigger condition for the MRM based on:
event information including at least one of a vehicle accident or a structure collapse incident being acquired by the transceiver based on at least one of a camera of the SV, a sensor of the SV, at least one vehicle neighboring the SV, or any combination thereof; and
a proportion of an area of a driving lane obstruction caused by at least one of the vehicle accident or the structure collapse incident in a driving lane of a road for the SV being greater than or equal to a threshold;
determine the trigger condition for the MRM when a specific height of the driving lane obstruction caused by the at least one of the vehicle accident or the structure collapse incident in the driving lane of the road for the SV is greater than or equal to a threshold; or
any combination thereof.

14. The device of claim 10, wherein in response to the determination that the MRM is needed based on the trigger condition for the MRM, the processor is further configured to:
select an MRM type based on internal and external information; and
change the selected MRM type in response to changes in at least one of internal factors, external factors, traffic conditions, or any combination thereof that exceed predetermined values.

15. The device of claim 14, wherein in response to a change in the MRM type while the ADS is performing the MRM, the processor is further configured to control the ADS to prevent multiple MRM type changes from delaying attainment of the MRC.

16. The device of claim 14, wherein during a change in the MRM type, the processor is further configured to allow a driver to take over control of the vehicle over the DDT.
